(19) United States
(12) Patent Application Publication
(10) Pub. No.: US 2026/0163782 A1
(43) Pub. Date: Jun. 11, 2026

(54) METHOD FOR REDUCING PAPR BY USING CYCLIC SHIFT IN TIME DOMAIN IN FDMA MODE FOR MULTIPLE ACCESS OF DFT-S-OFDM AND APPARATUS THEREFOR

(71) Applicant: LG ELECTRONICS INC., Seoul (KR)

(72) Inventors: Taehowan HONG, Seoul (KR); Dongsun LEE, Seoul (KR); Byounggill KIM, Seoul (KR); Jongku LEE, Seoul (KR); Sunam KIM, Seoul (KR); Hyunmin KIM, Seoul (KR)

(21) Appl. No.: 18/707,548

(22) PCT Filed: Nov. 10, 2021
(86) PCT No.: PCT/KR2021/016302

§ 371 Date: May 3, 2024

(51) Int. Cl. H04L 27/26; H04L 5/00

(52) U.S. Cl. CPC H04L 27/2628; H04L 5/0044; H04L 27/2678

(57) ABSTRACT

Provided are: a method for reducing a peak-to-average power ratio (PAPR) by using a cyclic shift in a time domain in a frequency division multiple access (FDMA) mode for multiple access of discrete Fourier transform spread orthogonal frequency division multiplexing (DFT-s-OFDM); and an apparatus therefor. A base station generates and transmits a downlink signal by: determining a cyclic shift value for each of a plurality of pieces of user equipment (UE); applying the cyclic shift value for each of the plurality of pieces of UE to each of signals for the plurality of pieces of UE, on which IDFT has been performed; and summing the respective signals for the plurality of pieces of UE, to which the cyclic shift value has been applied, and adding a cyclic prefix (CP).

### CROSS-REFERENCE TO RELATED APPLICATIONS

This application is the National Stage filing under 35 U.S.C. 371 of International Application No. PCT/KR2021/016302, filed on Nov. 10, 2021 which is hereby incorporated by reference in its entirety.

### TECHNICAL FIELD

The present disclosure relates to a method for reducing a Peak-to-Average Power Ratio (PAPR) by utilizing cyclic shifts in a time domain in a Frequency Division Multiple Access (FDMA) scheme for multiple access of Discrete Fourier Transform spread Orthogonal Frequency Division Multiplexing (DFT-s-OFDM), and an apparatus for the same.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

With the commercialization of NR, the equivalent of fifth generation (5G) mobile communications technology, research is beginning on sixth generation (6G) mobile communications technology. It is expected that 6G mobile communication technology will utilize frequency bands above 100 GHz. This is expected to increase the number of utilized frequencies by more than 10 times compared to 5G, and further increase the potential for utilizing spatial resources. These frequency bands above 100 GHz may be referred to as sub-terahertz (sub-THz).

As the number of devices supporting wireless communications and the amount of data traffic grows exponentially, 5G NR may be supported at higher frequencies and/or wider bandwidths. 5G NR uses Orthogonal Frequency Division Multiplexing (OFDM) as the waveform for the Downlink (DL), the same as LTE. However, at higher frequencies, the low efficiency of power amplifiers makes it difficult to use waveforms with high Peak-to-Average Power Ratio (PAPR) such as OFDM. Therefore, discussions have begun on new waveforms that can be used in the millimeter wave (mmWave) band of 5G NR, 71-114.25 GHz.

Similarly, new waveforms are also becoming important for 6G communications, which uses the THz band, which is higher than the frequencies used in 5G NR. The easiest approach to using waveforms with lower PAPR compared to OFDM is to apply Discrete Fourier Transform spread Orthogonal Frequency Division Multiplexing (DFT-s-OFDM), which is used in the Uplink (UL) of LTE and 5G NR, to the downlink.

### SUMMARY

Although DFT-s-OFDM is characterized by low PAPR, in order to apply DFT-s-OFDM to the downlink, it is necessary to support multiple accesses for multiple UEs. However, when multiple access is supported using FDMA, the advantage of low PAPR of DFT-s-OFDM decreases as the number of multiple access users increases. In other words, when multiple access is supported for FDMA-based DFT-s-OFDM, the time-domain signals of each UE may be overlapped, resulting in higher PAPR.

The present disclosure proposes a transmission and reception structure and signaling method to prevent the PAPR from increasing when multiple accesses of DFT-s-OFDM are supported by FDMA scheme in the downlink.

In an aspect, a method performed by a base station in a wireless communication system is provided. The method comprises, determining a cyclic shift value for each of a plurality of User Equipments (UEs), applying the cyclic shift value for each of the plurality of UEs to each of signals for the plurality of UEs on which an IDFT has been performed, generating and transmitting a downlink signal by summing each of the signals for the plurality of UEs to which the cyclic shift value has been applied and adding a Cyclic Prefix (CP).

In another aspect, a method performed by a User Equipment (UE) in a wireless communication system is provided. The method comprises, for decoding of a reception signal, removing a Cyclic Prefix (CP) from the reception signal, and compensating for a cyclic shift value assigned to the UE.

In another aspect, an apparatus for implementing the above method is provided.

The present disclosure can have various advantageous effects.

For example, for DFT-s-OFDM, which is being considered for downlink waveforms in the 5G mmWave band and 6G THz band, when supporting multiple access from multiple UEs via FDMA, the PAPR of the transmitted signal can be reduced by applying a cyclic shift to each UE's time domain signal.

For example, the lower PAPR of the transmitted signal may result in reduced back off power, which in turn may increase the average power of the transmitted signal, resulting in increased power efficiency from the base station perspective.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure are applied.

FIG. 2 shows an example of wireless devices to which implementations of the present disclosure are applied.

FIG. 3 shows an example of a wireless device to which implementations of the present disclosure are applied.

FIG. 4 shows an example of UE to which implementations of the present disclosure are applied.

FIGS. 5 and 6 show an example of protocol stacks in a 3GPP based wireless communication system to which implementations of the present disclosure are applied.

FIG. 7 shows a frame structure in a 3GPP based wireless communication system to which implementations of the present disclosure are applied.

FIG. 8 shows an example of FDMA among multiple access schemes using DFT-s-OFDM to which implementations of the present disclosure are applied.

FIG. 9 shows an example of PAPR in a case of using FDMA among multiple access schemes using DFT-s-OFDM to which implementations of the present disclosure are applied.

FIG. 10 shows an example of a method performed by a base station to which implementations of the present disclosure are applied.

FIG. 11 shows an example of a method performed by a UE to which implementations of the present disclosure are applied.

FIG. 12 shows an example of supporting multiple access of DFT-s-OFDM with FDMA scheme for a plurality of UEs to which implementations of the present disclosure are applied.

FIG. 13 shows an example of applying a cyclic shift for each UE in a time domain to which implementations of the present disclosure are applied.

FIG. 14 shows an example of a cyclic shift interval of a DFT-s-OFDM symbol to which implementations of the present disclosure are applied.

FIG. 15 shows an example of PAPR when applying a cyclic shift for each UE to which implementations of the present disclosure are applied.

FIG. 16 shows an example of a UE receiving a cyclic shift via DCI to which implementations of the present disclosure are applied.

FIG. 17 shows an example of a UE decoding a reception signal by compensating for a cyclic shift in the time domain to which implementations of the present disclosure are applied.

FIG. 18 shows an example of a UE decoding a reception signal by compensating for a cyclic shift in the frequency domain subject to which implementations of the present disclosure are applied.

FIG. 19 shows an example of applying a cyclic shift as a data allocation offset for each UE to which implementations of the present disclosure are applied.

FIG. 20 shows an example of applying a cyclic shift interval of a DFT-s-OFDM symbol as a data allocation offset to which implementations of the present disclosure are applied.

FIG. 21 shows an example PAPR when applying a cyclic shift as a data allocation offset for each UE to which implementations of the present disclosure are applied.

FIG. 22 shows an example of a UE decoding a reception signal by compensating for a data allocation offset to which implementations of the present disclosure are applied.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

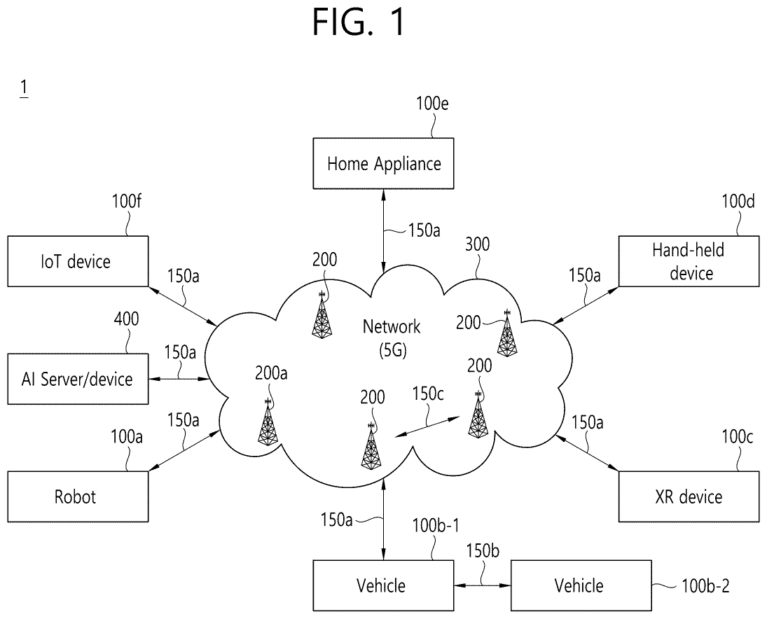

FIG. 1 shows an example of a communication system to which implementations of the present disclosure are applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a Closed-Circuit TV (CCTV), a recorder, or a black box.

The FinTech device may be, for example, a device capable of providing a financial service such as mobile payment. For example, the FinTech device may include a payment device or a Point of Sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through Computer Graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding frequency | |
|---|---|---|
| designation | range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names.

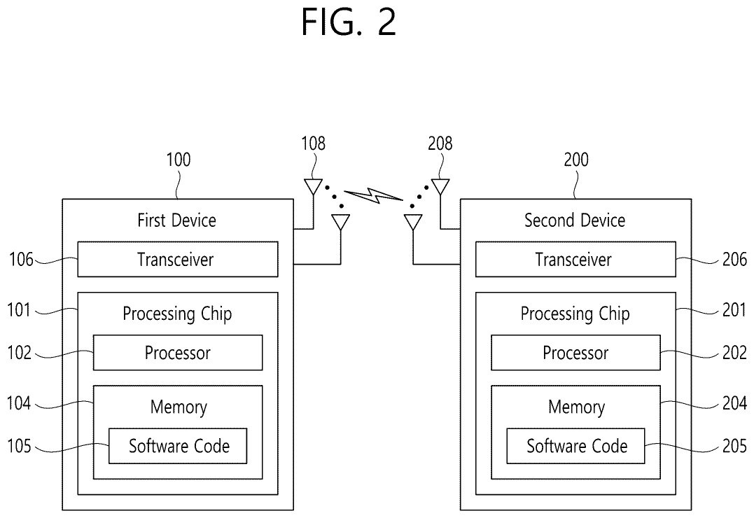

FIG. 2 shows an example of wireless devices to which implementations of the present disclosure are applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs) and/or one or more Service Data Units (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable ROMs (EEPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a Node B (NB), an eNode B (eNB), or a gNB.

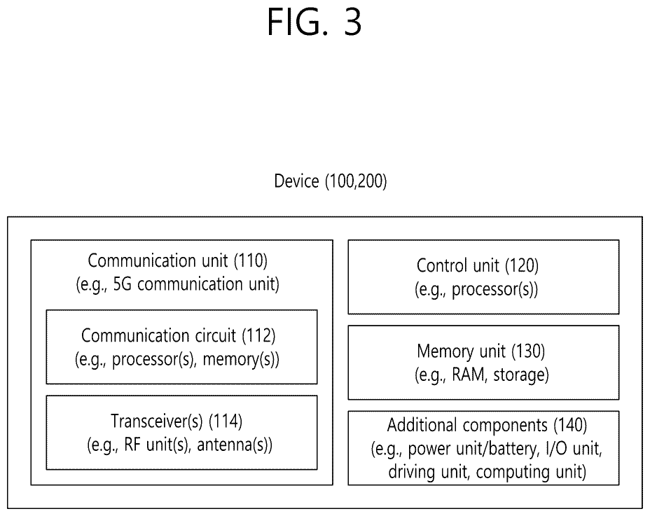

FIG. 3 shows an example of a wireless device to which implementations of the present disclosure are applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, Input/Output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an Application Processor (AP), an Electronic Control Unit (ECU), a Central Processing Unit (CPU), a Graphical Processing Unit (GPU), and a memory control processor. As another example, the memory unit 130 may be configured by a RAM, a Dynamic RAM (DRAM), a ROM, a flash memory, a volatile memory, a non-volatile memory, and/or a combination thereof.

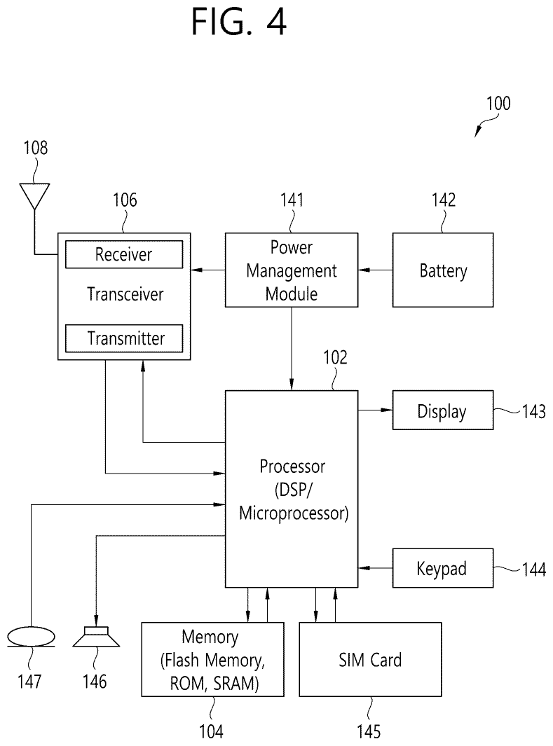

FIG. 4 shows an example of UE to which implementations of the present disclosure are applied.

Referring to FIG. 4, a UE 100 may correspond to the first wireless device 100 of FIG. 2 and/or the wireless device 100 or 200 of FIG. 3.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

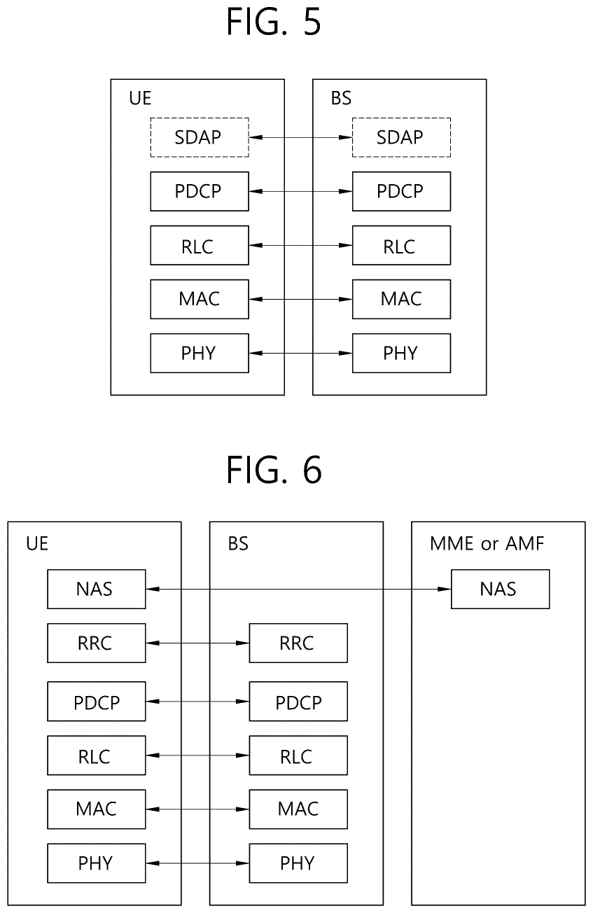

FIGS. 5 and 6 show an example of protocol stacks in a 3GPP based wireless communication system to which implementations of the present disclosure are applied.

In particular, FIG. 5 illustrates an example of a radio interface user plane protocol stack between a UE and a BS and FIG. 6 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 5, the user plane protocol stack may be divided into Layer 1 (i.e., a PHY layer) and Layer 2. Referring to FIG. 6, the control plane protocol stack may be divided into Layer 1 (i.e., a PHY layer), Layer 2, Layer 3 (e.g., an RRC layer), and a Non-Access Stratum (NAS) layer. Layer 1, Layer 2 and Layer 3 are referred to as an Access Stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network Quality of Service (QoS) flows.

In the 3GPP NR system, the main services and functions of the MAC sublayer include: mapping between logical channels and transport channels; multiplexing/de-multiplexing of MAC SDUs belonging to one or different logical channels into/from Transport Blocks (TB) delivered to/from the physical layer on transport channels; scheduling information reporting; error correction through Hybrid Automatic Repeat reQuest (HARQ) (one HARQ entity per cell in case of Carrier Aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast Control Channel (BCCH) is a downlink logical channel for broadcasting system control information, Paging Control Channel (PCCH) is a downlink logical channel that transfers paging information, system information change notifications and indications of ongoing Public Warning Service (PWS) broadcasts, Common Control Channel (CCCH) is a logical channel for transmitting control information between UEs and network and used for UEs having no RRC connection with the network, and Dedicated Control Channel (DCCH) is a point-to-point bi-directional logical channel that transmits dedicated control information between a UE and the network and used by UEs having an RRC connection. Dedicated Traffic Channel (DTCH) is a point-to-point logical channel, dedicated to one UE, for the transfer of user information. A DTCH can exist in both uplink and downlink. In downlink, the following connections between logical channels and transport channels exist: BCCH can be mapped to Broadcast Channel (BCH); BCCH can be mapped to Downlink Shared Channel (DL-SCH); PCCH can be mapped to Paging Channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to Uplink Shared Channel (UL-SCH); DCCH can be mapped to UL-SCH; and DTCH can be mapped to UL-SCH.

The RLC sublayer supports three transmission modes: Transparent Mode (TM), Unacknowledged Mode (UM), and Acknowledged Mode (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using Robust Header Compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS Flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5G Core network (5GC) or Next-Generation Radio Access Network (NG-RAN); establishment, maintenance and release of an RRC connection between the UE and NG-RAN; security functions including key management; establishment, configuration, maintenance and release of Signaling Radio Bearers (SRBs) and Data Radio Bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

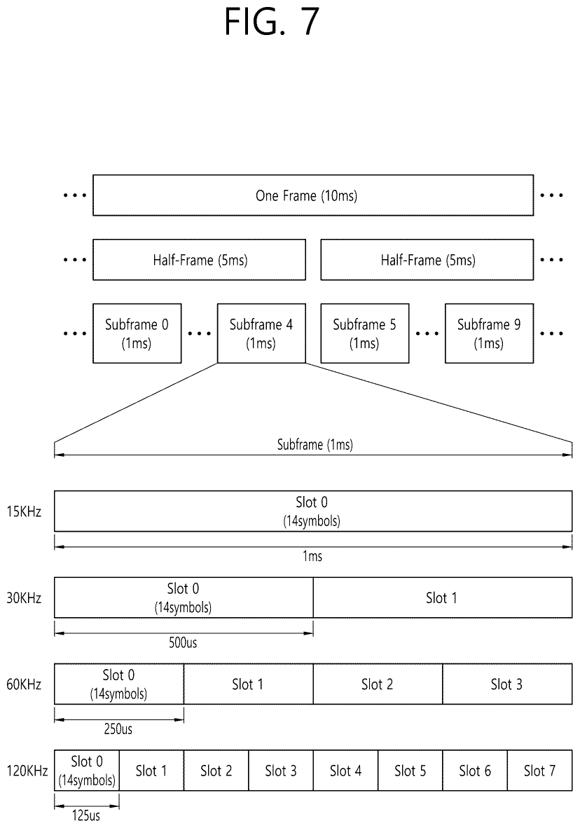

FIG. 7 shows a frame structure in a 3GPP based wireless communication system to which implementations of the present disclosure are applied.

The frame structure shown in FIG. 7 is purely exemplary and the number of subframes, the number of slots, and/or the number of symbols in a frame may be variously changed. In the 3GPP based wireless communication system, OFDM numerologies (e.g., SCS, Transmission Time Interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or Cyclic Prefix (CP)-OFDM symbols), SC-FDMA symbols (or Discrete Fourier Transform-spread-OFDM (DFT-s-OFDM) symbols).

Referring to FIG. 7, downlink and uplink transmissions are organized into frames. Each frame has Tf=10 ms duration. Each frame is divided into two half-frames, where each of the half-frames has 5 ms duration. Each half-frame consists of 5 subframes, where the duration Tsf per subframe is 1 ms. Each subframe is divided into slots and the number of slots in a subframe depends on a subcarrier spacing. Each slot includes 14 or 12 OFDM symbols based on a CP. In a normal CP, each slot includes 14 OFDM symbols and, in an extended CP, each slot includes 12 OFDM symbols. The numerology is based on exponentially scalable subcarrier spacing Δf=2^{u}*15 KHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slots}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at Common Resource Block (CRB) N^{start,u}_{grid} indicated by higher-layer signaling (e.g., RRC signaling), where N^{size,u}_{grid,x} is the number of Resource Blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a Resource Element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain.

In the 3GPP NR system, RBs are classified into CRBs and Physical Resource Blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a BandWidth Part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the PHY layer, the uplink transport channels UL-SCH and Random Access Channel (RACH) are mapped to their physical channels Physical Uplink Shared Channel (PUSCH) and Physical Random Access Channel (PRACH), respectively, and the downlink transport channels DL-SCH, BCH and PCH are mapped to Physical Downlink Shared Channel (PDSCH), Physical Broadcast Channel (PBCH) and PDSCH, respectively. In the PHY layer, Uplink Control Information (UCI) is mapped to PUCCH, and Downlink Control Information (DCI) is mapped to Physical Downlink Control Channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

LTE/LTE-A uses Cyclic Prefix-based Orthogonal Frequency Division Multiplexing (CP-OFDM) in the downlink and Discrete Fourier Transform spread Orthogonal Frequency Division Multiplexing (DFT-s-OFDM) in the uplink. DFT-s-OFDM is better known by the name Single Carrier Frequency Division Multiple Access (SC-FDMA). 5G NR also uses CP-OFDM as the access scheme, and unlike LTE, it also supports CP-OFDM in the uplink. DFT-s-OFDM is still valid as the access scheme in the uplink for 5G NR, and all devices that support 5G NR should be able to support it. The network may decide whether to use CP-OFDM or DFT-s-OFDM for the uplink.

When using CP-OFDM in the frequency band corresponding to FR2 in 5G NR and/or the frequency band corresponding to the THz band in 6G, the Peak-to-Average Power Ratio (PAPR) may increase. As a result, there are ongoing discussions to use DFT-s-OFDM, which has a relatively low PAPR, as the access scheme for the downlink.

In order to apply DFT-s-OFDM in the downlink, it is necessary to support multiple accesses for multiple UEs. There are two main approaches to multiple access using DFT-s-OFDM: TDMA and FDMA.

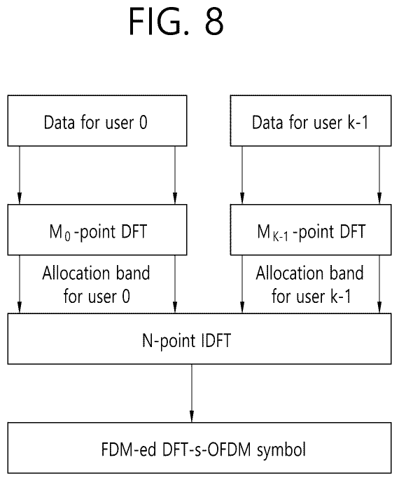

FIG. 8 shows an example of FDMA among multiple access schemes using DFT-s-OFDM to which implementations of the present disclosure are applied.

Among the multiple access schemes using DFT-s-OFDM, FDMA is more efficient than TDMA in terms of spectrum and/or time delay. Referring to FIG. 8, first, an M₀-point . . . Mₖ₋₁-point DFT is performed on the data for each user (data for user 0 . . . data for user k−1 in FIG. 8), respectively, and each user is assigned a frequency band. Then, an N-point Inverse DFT (IDFT) is performed, and finally, an FDM-ed DFT-s-OFDM symbol is generated.

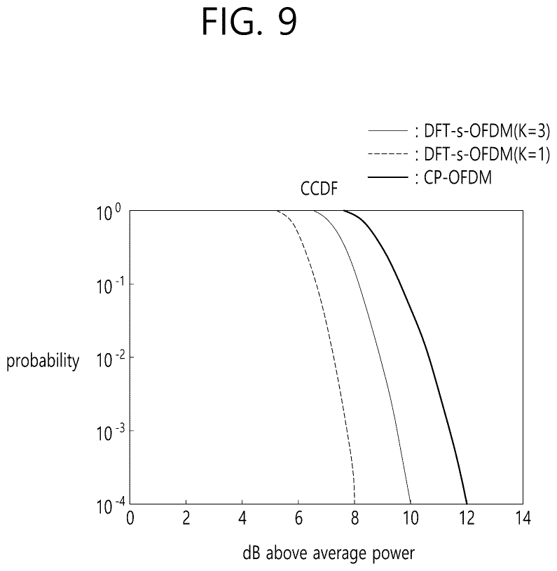

FIG. 9 shows an example of PAPR in a case of using FDMA among multiple access schemes using DFT-s-OFDM to which implementations of the present disclosure are applied.

FIG. 9 shows the PAPR in a case that CP-OFDM is used as the access scheme, in a case that DFT-s-OFDM is used as the access scheme when the number of FDM-ed UEs is 1, and in a case that DFT-s-OFDM is used as the access scheme when the number of FDM-ed UEs is 3. Also, in FIG. 9, it is assumed that the IFT size is 1024, the total data size is 1020, and the modulation order is Quadrature Phase Shift Keying (QPSK).

Referring to FIG. 9, when multiple access is performed with FDMA using DFT-s-OFDM, as the number of UEs increases, the PAPR increases due to the superposition of the signal power of each UE at the same time, and gradually approaches the PAPR of the CP-OFDM access scheme.

Therefore, a separate technique for applying DFT-s-OFDM to the downlink is required to effectively reduce the PAPR.

According to implementations of the present disclosure, a method may be provided for cyclically shifting the time domain signal of each UE to find an optimal cyclic shift value that results in a lower overall PAPR.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

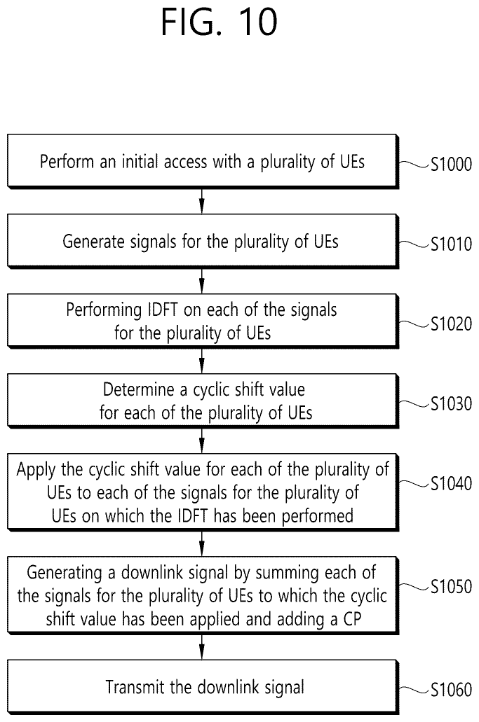

FIG. 10 shows an example of a method performed by a base station to which implementations of the present disclosure are applied.

In step S1000, the method comprises performing an initial access with a plurality of UEs.

In step S1010, the method comprises generating signals for the plurality of UEs.

In step S1020, the method comprises performing an IDFT on each of the signals for the plurality of UEs.

In step S1030, the method comprises determining a cyclic shift value for each of the plurality of UEs.

In some implementations, the cyclic shift value for each of the plurality of UEs may be a cyclic shift value capable of minimizing a PAPR. Or, the cyclic shift value for each of the plurality of UEs may be a cyclic shift value such that a PAPR is below a threshold value.

In step S1040, the method comprises applying the cyclic shift value for each of the plurality of UEs to each of the signals for the plurality of UEs on which the IDFT has been performed.

In step S1050, the method comprises generating a downlink signal by summing each of the signals for the plurality of UEs to which the cyclic shift value has been applied and adding a CP.

In step S1060, the method comprises transmitting the downlink signal.

In some implementations, the method may further comprise receiving, from each of the plurality of UEs, a UE capability indicative of being able to compensate for the cyclic shift value. Furthermore, the method may further comprise transmitting the cyclic shift value for each of the plurality of UEs to each of the plurality of UEs via DCI.

In some implementations, the method may further comprise generating second signals for each of the plurality of UEs by applying a data allocation offset based on the cyclic shift value for each of the plurality of UEs, generating a second downlink signal by summing each of the second signals for the plurality of UEs and adding a CP, and transmitting the second downlink signal.

Furthermore, the method in perspective of the base station described above in FIG. 10 may be performed by the second wireless device 200 shown in FIG. 2, and/or the wireless device 100 shown in FIG. 3.

More specifically, the base station comprises at least one transceiver, at least one processor, and at least one memory operably connectable to the at least one processor. The at least one memory stores instructions that, based on being executed by the at least one processor, perform operations below.

The base station performs an initial access with a plurality of UEs.

The base station generates signals for the plurality of UEs.

The base station performs an IDFT on each of the signals for the plurality of UEs.

The base station determines a cyclic shift value for each of the plurality of UEs.

In some implementations, the cyclic shift value for each of the plurality of UEs may be a cyclic shift value capable of minimizing a PAPR. Or, the cyclic shift value for each of the plurality of UEs may be a cyclic shift value such that a PAPR is below a threshold value.

The base station applies the cyclic shift value for each of the plurality of UEs to each of the signals for the plurality of UEs on which the IDFT has been performed.

The base station generates a downlink signal by summing each of the signals for the plurality of UEs to which the cyclic shift value has been applied and adding a CP.

The base station transmits, using the at least one transceiver, the downlink signal.

In some implementations, the base station may receive, from each of the plurality of UEs, a UE capability indicative of being able to compensate for the cyclic shift value. Furthermore, the base station may transmit the cyclic shift value for each of the plurality of UEs to each of the plurality of UEs via DCI.

In some implementations, the base station may generate second signals for each of the plurality of UEs by applying a data allocation offset based on the cyclic shift value for each of the plurality of UEs, generate a second downlink signal by summing each of the second signals for the plurality of UEs and adding a CP, and transmit the second downlink signal.

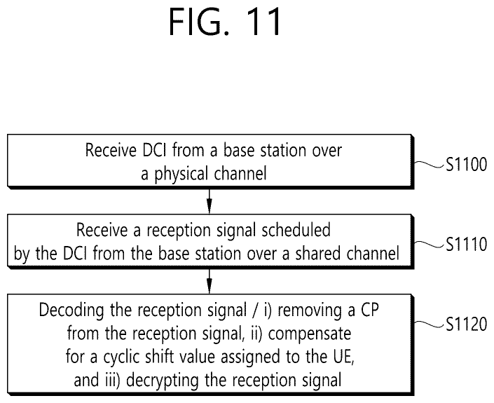

FIG. 11 shows an example of a method performed by a UE to which implementations of the present disclosure are applied.

In step S1100, the method comprises receiving DCI from a base station over a physical channel.

In step S1110, the method comprises receiving a reception signal scheduled by the DCI from the base station over a shared channel.

In step S1120, the method comprises decoding the reception signal. Decoding of the reception signal comprises, i) removing a CP from the reception signal, ii) compensating for a cyclic shift value assigned to the UE, and iii) decrypting the reception signal.

In some implementations, the method may further comprise reporting, to the base station, a UE capability indicative of being able to compensate for the cyclic shift value for the reception signal.

In some implementations, the DCI may comprise the cyclic shift value.

In some implementations, the method may further comprise, after compensating for the cyclic shift value assigned to the UE, performing an N-point DFT and an M-point IDFT. Or, the method may further comprise performing an N-point DFT before compensating for the cyclic shift value assigned to the UE, and performing an M-point IDFT after compensating for the cyclic shift value assigned to the UE.

In some implementations, the method may further comprise receiving a second reception signal over the shared channel, and decoding the second reception signal. Decoding of the second reception signal may comprise, i) removing a CP from the second reception signal, ii) performing an N-point DFT and an M-point IDFT, iii) compensating for a data allocation offset based on the cyclic shift value assigned to the UE, and iv) decrypting the aid second reception signal. In this case, the DCI may comprise the data allocation offset.

Furthermore, the method in perspective of the UE described above in FIG. 11 may be performed by the first wireless device 100 shown in FIG. 2, the wireless device 100 shown in FIG. 3, and/or the UE 100 shown in FIG. 4.

More specifically, the UE comprises at least one transceiver, at least one processor, and at least one memory operably connectable to the at least one processor. The at least one memory stores instructions that, based on being executed by the at least one processor, perform operations below.

The UE receives, using the at least one transceiver, DCI from a base station over a physical channel.

The UE receives, using the at least one transceiver, a reception signal scheduled by the DCI from the base station over a shared channel.

The UE decodes the reception signal. Decoding of the reception signal comprises, i) removing a CP from the reception signal, ii) compensating for a cyclic shift value assigned to the UE, and iii) decrypting the reception signal.

In some implementations, the UE may report, to the base station using the at least one transceiver, a UE capability indicative of being able to compensate for the cyclic shift value for the reception signal.

In some implementations, the DCI may comprise the cyclic shift value.

In some implementations, after compensating for the cyclic shift value assigned to the UE, the UE may perform an N-point DFT and an M-point IDFT. Or, the UE may perform an N-point DFT before compensating for the cyclic shift value assigned to the UE, and performing an M-point IDFT after compensating for the cyclic shift value assigned to the UE.

In some implementations, the UE may receive, using the at least one transceiver, a second reception signal over the shared channel, and decode the second reception signal. Decoding of the second reception signal may comprise, i) removing a CP from the second reception signal, ii) performing an N-point DFT and an M-point IDFT, iii) compensating for a data allocation offset based on the cyclic shift value assigned to the UE, and iv) decrypting the aid second reception signal. In this case, the DCI may comprise the data allocation offset.

Furthermore, the method in perspective of the UE described above in FIG. 11 may be performed by control of the processor 102 included in the first wireless device 100 shown in FIG. 2, by control of the communication unit 110 and/or the control unit 120 included in the wireless device 100 shown in FIG. 3, and/or by control of the processor 102 included in the UE 100 shown in FIG. 4.

More specifically, a processing apparatus operating in a wireless communication system comprises at least one processor, and at least one memory operably connectable to the at least one processor. The at least one processor is adapted to perform operations comprising: obtaining DCI, obtaining a reception signal scheduled by the DCI, and decoding the reception signal. Decoding of the reception signal comprises, i) removing a CP from the reception signal, ii) compensating for a cyclic shift value assigned to the UE, and iii) decrypting the reception signal.

Furthermore, the method in perspective of the UE described above in FIG. 11 may be performed by a software code 105 stored in the memory 104 included in the first wireless device 100 shown in FIG. 2.

The technical features of the present disclosure may be embodied directly in hardware, in a software executed by a processor, or in a combination of the two. For example, a method performed by a wireless device in a wireless communication may be implemented in hardware, software, firmware, or any combination thereof. For example, a software may reside in RAM, flash memory, ROM, EPROM, EEPROM, registers, hard disk, a removable disk, a CD-ROM, or any other storage medium.

Some example of storage medium may be coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include RAM such as synchronous dynamic random access memory (SDRAM), ROM, non-volatile random access memory (NVRAM), EEPROM, flash memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some implementations of the present disclosure, a non-transitory computer-readable medium (CRM) has stored thereon a plurality of instructions.

More specifically, CRM stores instructions that, based on being executed by at least one processor, perform operations comprising: obtaining DCI, obtaining a reception signal scheduled by the DCI, and decoding the reception signal. Decoding of the reception signal comprises, i) removing a CP from the reception signal, ii) compensating for a cyclic shift value assigned to the UE, and iii) decrypting the reception signal.

Hereinafter, various implementations of the present disclosure will be described with reference to the drawings.

According to implementations of the present disclosure, a method may be provided to address the problem of high PAPR by cyclic shifting in the time domain of each UE, when DFT-s-OFDM supports multiple accesses of a plurality of UEs with FDMA.

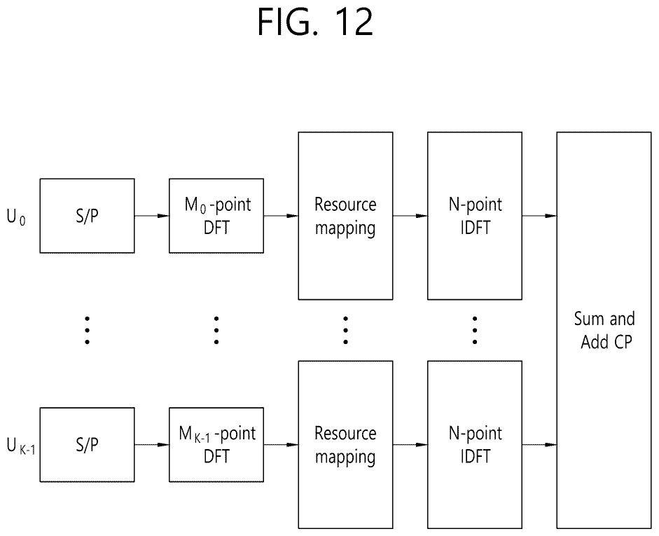

FIG. 12 shows an example of supporting multiple access of DFT-s-OFDM with FDMA scheme for a plurality of UEs to which implementations of the present disclosure are applied.

Referring to FIG. 12, the transmitting end first performs M-point (M₀-point . . . Mₖ₋₁-point for each UE, respectively) DFT on the signal of each UE and performs resource mapping. Then, compared to FIG. 8 described above, the transmitting end performs an N-point IDFT on the signal of each UE separately to convert the signal of each UE into a signal in the time domain. Thus, the signals for each UE may be separated from each other in the time domain. In general, the size of the IDFT may be larger than the size of the DFT (i.e., N>M). Then, the transmitting end adds the time domain signal of each UE to each other and adds the CP. The time domain signal of each UE may overlap in time domain, resulting in a higher PAPR.

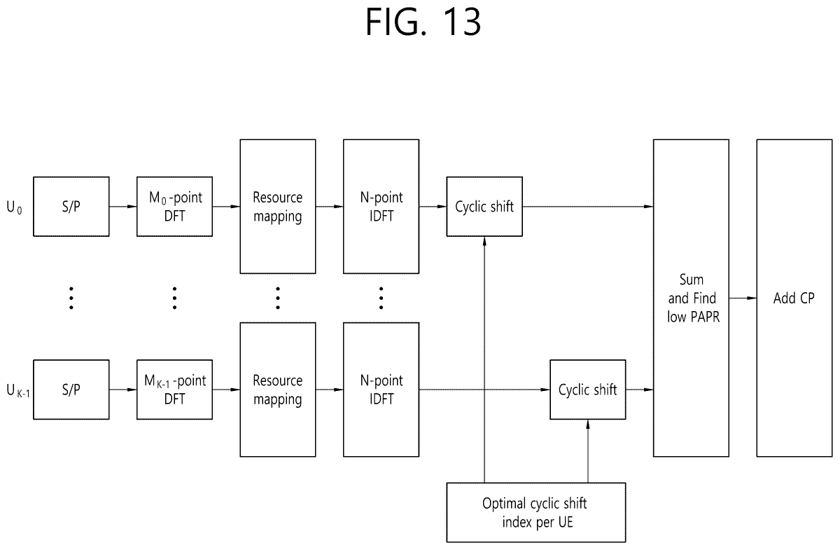

FIG. 13 shows an example of applying a cyclic shift for each UE in a time domain to which implementations of the present disclosure are applied.

Referring to FIG. 13, the transmitting end performs M-point DFT, resource mapping, and N-point IDFT on the signal of each UE, and then finds a cyclic shift (or cyclic shift index) that results in a lower value of PAPR while applying a cyclic shift to the time domain signal for each UE. That is, by applying a cyclic shift to the time domain signal for each UE, the overlapping position of the time domain signal of each UE when added together may change. In this way, a cyclic shift (or cyclic shift index) is found for each UE that can result in a relatively lower PARR for each UE.

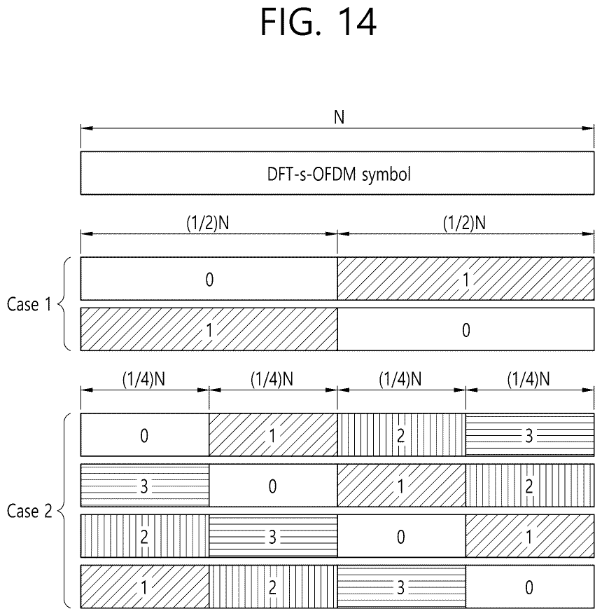

FIG. 14 shows an example of a cyclic shift interval of a DFT-s-OFDM symbol to which implementations of the present disclosure are applied.

The interval of the cyclic shift applied for each UE may be one sample unit in the IDFT size (i.e., N) of the DFT-s-OFDM symbol. Referring to FIG. 14, in case 1, half of the DFT-s-OFDM symbol is assigned to the cyclic shift interval, and in case 2, one quarter of the DFT-s-OFDM symbol is assigned to the cyclic shift interval.

The PAPR may be minimized when the time domain signal of each UE is added together by applying the above cyclic shift (or cyclic shift index). Alternatively, the PAPR may be below a threshold value when the time domain signal of each UE is added together by applying the above cyclic shift (or cyclic shift index). For example, if the number of UEs being multiplexed with FDMA in DFT-s-OFDM is K, and the interval of cyclic shift (or cyclic shift index) that is divided based on DFT-s-OFDM symbol is L (e.g., in FIG. 14, L=2 in case 1 and L=4 in case 2), the transmitting end may need to perform L^{K} number of operations to find a combination of cyclic shifts (or cyclic shift indexes) that minimizes the PAPR. The transmitting end may perform L^{K} number of operations to find a combination of cyclic shifts (or cyclic shift indices) that minimizes the PAPR, or the transmitting end may determine a threshold value for the target PAPR and stop operations when it finds a combination of cyclic shifts (or cyclic shift indices) that satisfies the threshold value, and use that cyclic shift (or cyclic shift index).

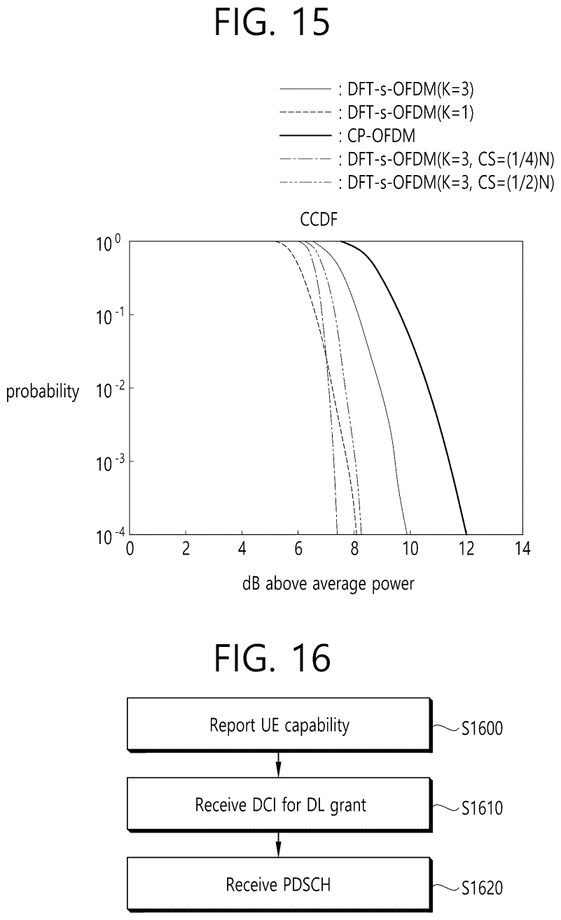

FIG. 15 shows an example of PAPR when applying a cyclic shift for each UE to which implementations of the present disclosure are applied.

FIG. 15 shows the PAPR in a case that CP-OFDM is used as the access scheme, in a case that DFT-s-OFDM is used as the access scheme when the number of FDM-ed UEs is 1 (no cyclic shift), in a case that DFT-s-OFDM is used as the access scheme when the number of FDM-ed UEs is 3 (no cyclic shift), in a case that DFT-s-OFDM is used as the access scheme when the number of FDM-ed UEs is 3 (cyclic shift interval 1/4), and in a case that DFT-s-OFDM is used as the access scheme when the number of FDM-ed UEs is 3 (cyclic shift interval 1/2). Also, in FIG. 15, it is assumed that the IFT size (N) is 1024, the FFT size (M) is 340, the total data size is 1020, and the modulation order is QPSK.

Referring to FIG. 15, it can be seen that the PAPR decreases as the cyclic shift interval decreases. That is, a cyclic shift interval of 1/4 results in a lower PAPR than a cyclic shift interval of 1/2, resulting in better performance. However, the computational complexity increases as the cyclic shift interval decreases, so there is a trade-off between PAPR performance and computational complexity.

FIG. 16 shows an example of a UE receiving a cyclic shift via DCI to which implementations of the present disclosure are applied.

As described above, if the base station has applied a cyclic shift (or cyclic shift index) to the time domain signal for each UE to reduce PAPR, the base station should transmit the cyclic shift (or cyclic shift index) applied for each UE to the UE so that the UE can decode the reception signal using the received cyclic shift (or cyclic shift index). The base station may use DCI to transmit the applied cyclic shift (or cyclic shift index) for each UE to the UEs.

Referring to FIG. 16, in step S1600, the UE reports its UE capability to the base station. The UE capability may indicate whether the UE has the ability to compensate for the cyclic shift (or cyclic shift index) by utilizing the cyclic shift (or cyclic shift index) when decoding a reception signal to which the cyclic shift (or cyclic shift index) has been applied.

In step S1610, the UE receives the DCI for the DL grant. The base station first checks the UE capability received from the UE. If the UE has the ability to decode the reception signal to which the cyclic shift (or cyclic shift index) has been applied while compensating for the cyclic shift (or cyclic shift index), the base station finds the cyclic shift (or cyclic shift index) for each UE that can reduce the PAPR of the transmitted signal, and transmits a DCI to the UE containing the cyclic shift (or cyclic shift index) assigned to the UE.

In step S1620, the UE receives a signal and/or data via the PDSCH. The UE decodes the reception signal and/or data by compensating for the cyclic shift (or cyclic shift index) received in step S1610.

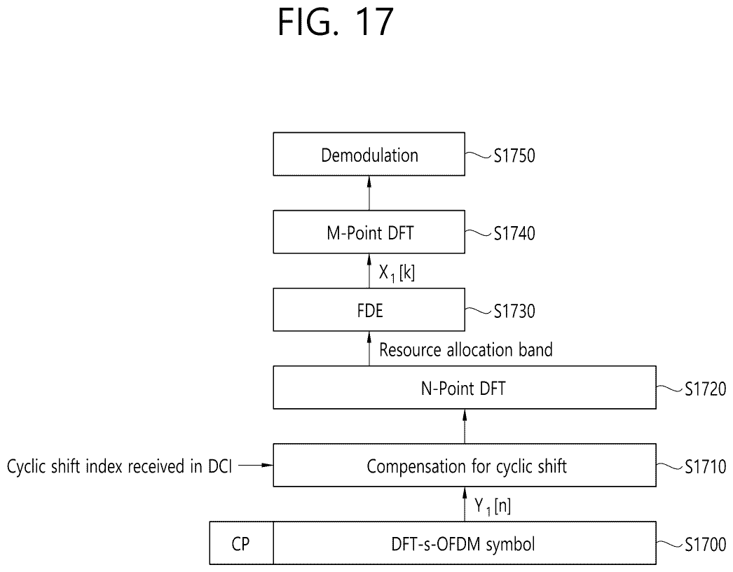

FIG. 17 shows an example of a UE decoding a reception signal by compensating for a cyclic shift in the time domain to which implementations of the present disclosure are applied.

In step S1700, the UE receives a signal (i.e., a DFT-s-OFDM symbol) via PDSCH. The CP is still attached. It is also assumed that the UE has received the cyclic shift (or cyclic shift index) from the base station in advance.

In step S1710, the UE removes the CP and compensates for the cyclic shift using the cyclic shift (or cyclic shift index) received from the base station.

In step S1720, the UE performs N-point DFT.

In step S1730, the UE performs channel estimation in the frequency domain, i.e., Frequency Domain channel Estimation (FDE).

In other words, in the process of compensating for the cyclic shift at the receiving end, the shift in the time domain may be compensated for in the process of estimating the channel in the frequency domain, as shown in Equation 1 below. Therefore, the original signal may be restored by channel estimation in the frequency domain.

$${Y}_{l} [ k ] = {\sum }_{n = 0}^{N - 1} {y}_{l} [ n - C ] {e}^{- \frac{j 2 π k n}{N}} = {\sum }_{n = 0}^{N - 1} \{ {h}_{l} [ n - C ] * {x}_{l}^{′} [ n - C ] + {z}_{l} [ n - C ] \} {e}^{- \frac{j 2 π k n}{N}} with {x}_{l}^{′} [ n ] = {x}_{l} [ n + C ] = {\sum }_{n = 0}^{N - 1} \{ {h}_{l} [ n - C ] * {x}_{l} [ n ] \} {e}^{- \frac{j 2 π k n}{N}} + {Z}_{l} [ k ] = {\sum }_{n = 0}^{N - 1} \{ {\sum }_{m = 0}^{∞} {h}_{l} [ n - m - C ] {x}_{l} [ m ] \} {e}^{- \frac{j 2 π k n}{N}} + {Z}_{l} [ k ] = {\sum }_{n = 0}^{N - 1} \{ \frac{1}{N} {\sum }_{i = 0}^{N - 1} {H}_{l} [ i ] {e}^{\frac{j 2 π i ( n - m - C )}{N}} {\sum }_{m = 0}^{∞} {x}_{l} [ m ] \} {e}^{- \frac{j 2 π k n}{N}} + {Z}_{l} [ k ] = \frac{1}{N} {\sum }_{i = 0}^{N - 1} \{ {\sum }_{m = 0}^{∞} x [ m ] {e}^{- \frac{j 2 π im}{N}} {H}_{l} [ i ] {\sum }_{n = 0}^{N - 1} {e}^{- \frac{j 2 π ( k - i ) n}{N} \} {e}^{- \frac{j 2 π i C}{N}} + {Z}_{l} [ k ]} = {H}_{l} [ k ] {X}_{l} [ k ] {e}^{- \frac{j 2 π k C}{N}} + {Z}_{l} [ k ] with {{\sum }_{n = 0}}^{N - 1} {e}^{\frac{j 2 π ( k - i ) n}{N}} = {e}^{\frac{j 2 π ( k - i ) ( N - 1 )}{N}} = \{ \begin{matrix}N & for k = i \\ 0 & for k \neq i\end{matrix} \qquad [ Equation 1 ]$$

In Equation 1, Y denotes the reception signal in the frequency domain, y denotes the reception signal in the time domain, X denotes the transmission signal in the frequency domain, x denotes the transmission signal in the time domain, H denotes the channel in the frequency domain, h denotes the channel in the time domain, Z denotes the Additive White Gaussian Noise (AWGN) in the frequency domain, z denotes the AWGN in the time domain, 1 denotes the OFDM symbol number, N denotes the IDFT size, n denotes the time sample number, K denotes the element number, and C denotes the cyclic shift index.

In step S1740, the UE performs the M-point IDFT.

In step S1750, the UE performs demodulation to finally decode the reception signal.

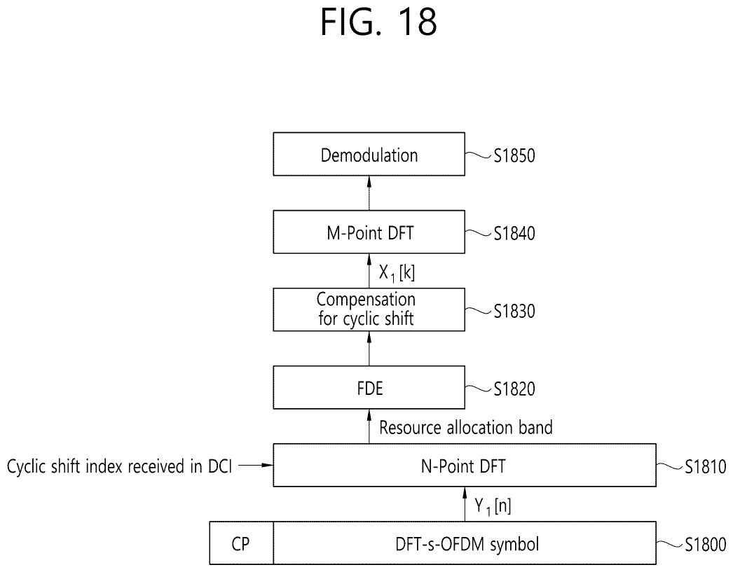

FIG. 18 shows an example of a UE decoding a reception signal by compensating for a cyclic shift in the frequency domain subject to which implementations of the present disclosure are applied.

In step S1800, the UE receives a signal (i.e., a DFT-s-OFDM symbol) via PDSCH. The CP is still attached. It is also assumed that the UE has received the cyclic shift (or cyclic shift index) from the base station in advance.

In step S1810, the UE removes the CP and performs N-point DFT.

In step S1820, the UE performs channel estimation in the frequency domain, i.e., FDE.

In step S1830, the UE compensates for the cyclic shift using the cyclic shift (or cyclic shift index) received from the base station.

That is, the effect of the cyclic shift applied by the base station to the time domain signal can be seen as a phase rotation in the frequency domain, as shown in Equation 2.

$${Y}_{l} [ k ] = \frac{1}{N} {\sum }_{𝔫 = 0}^{N - 1} {x}_{l} [ n + C ] {e}^{- \frac{j 2 π k n}{N}} = \frac{1}{N} {\sum }_{p = 0}^{N - 1} {X}_{l} [ p ] {e}^{\frac{j2 πpC}{N}} {\sum }_{n = 0}^{N - 1} {e}^{\frac{j 2 π ( p - k ) n}{N}} = {X}_{[} [ k ] {e}^{\frac{j 2 π k C}{N}} with {\sum }_{n = 0}^{N - 1} {e}^{\frac{j 2 π ( p - k ) n}{N}} = {e}^{\frac{j 2 π ( p - k ) ( N - 1 )}{N}} = \{ \begin{matrix}N & for k = p \\ 0 & for k \neq p\end{matrix} \qquad [ Equation 2 ]$$

Therefore, the UE can decode the reception signal by compensating for the cyclic shift for the rotated phase in the frequency domain. Alternatively, if the UE generates a reference signal for FDE, it can consider the phase rotation for the cyclic shift when generating it, and there is no need to separately compensate for the phase rotation for the cyclic shift directly in the data.

In step S1840, the UE performs the M-point IDFT.

In step S1850, the UE performs demodulation to finally decode the reception signal.

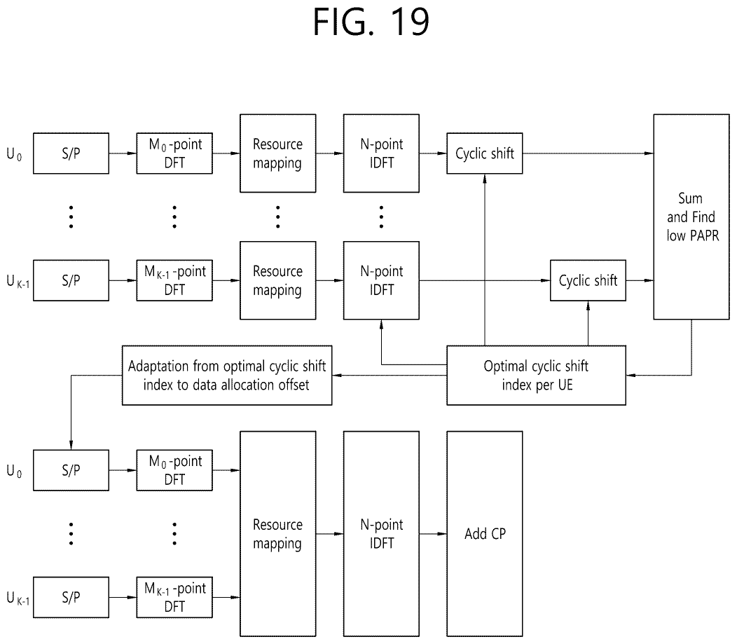

FIG. 19 shows an example of applying a cyclic shift as a data allocation offset for each UE to which implementations of the present disclosure are applied.

The example of FIG. 19 shows a variation of the method of applying a cyclic shift for each UE in the time domain to reduce the PAPR described above in FIGS. 13 through 18, wherein the cyclic shift for each UE in the time domain is applied as a data allocation offset in the input stage. This may reduce the complexity of decoding at the receiving end.

Referring to FIG. 19, the transmitting end finds the cyclic shift (or cyclic shift index) that lowers the PAPR for each UE according to the method described above in FIGS. 13 to 18, and then applies the data allocation offset in the input stage prior to the DFT at the same rate. In other words, the cyclic shift (or cyclic shift index) that lowers the PAPR for each UE is applied as the data allocation offset of the input signal altogether. Therefore, after applying the data allocation offset, no additional cyclic shifts need to be applied in the time domain, with the same effect of lowering the PAPR at the transmitting end.

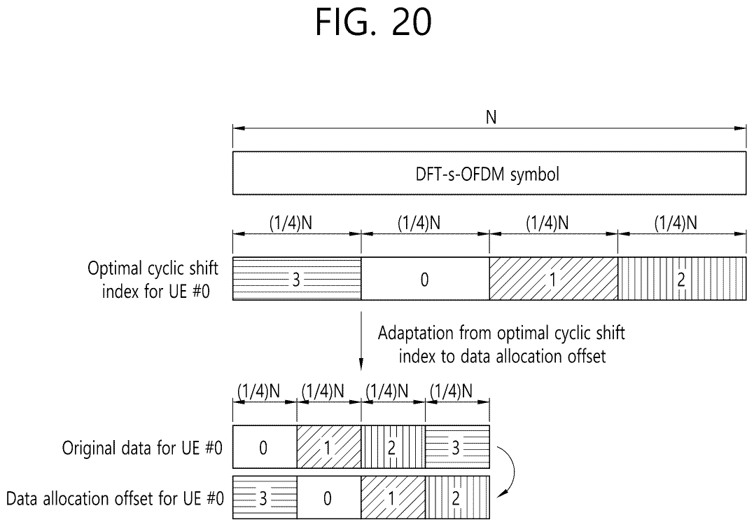

FIG. 20 shows an example of applying a cyclic shift interval of a DFT-s-OFDM symbol as a data allocation offset to which implementations of the present disclosure are applied.

In FIG. 20, the DFT-s-OFDM symbol is divided into four blocks, and the cyclic shift of each block is applied as a data allocation offset at the input stage. That is, if the optimal cyclic shift index of UE #0 that can reduce the PAPR at the transmitting end is {3, 0, 1, 2}, the transmitting may also divide the input signal/data of UE #0 into four blocks, and apply {3, 0, 1, 2} as a data allocation offset to each of the divided input signals/data.

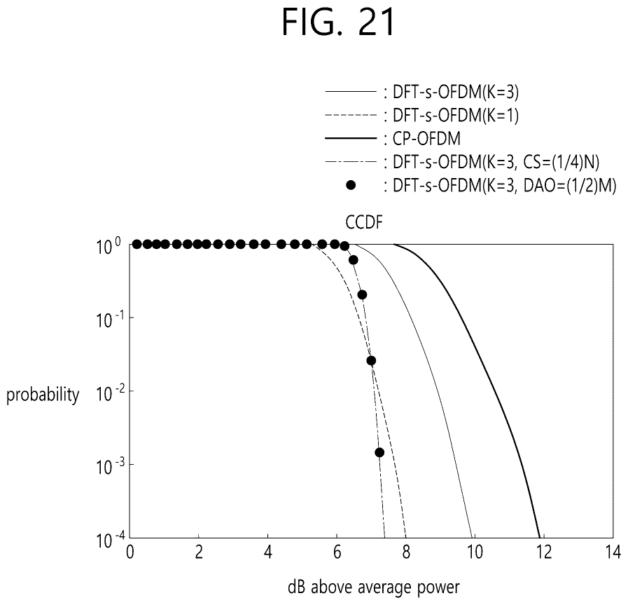

FIG. 21 shows an example PAPR when applying a cyclic shift as a data allocation offset for each UE to which implementations of the present disclosure are applied.

FIG. 21 shows the PAPR in a case that CP-OFDM is used as the access scheme, in a case that DFT-s-OFDM is used as the access scheme when the number of FDM-ed UEs is 1 (no cyclic shift), in a case that DFT-s-OFDM is used as the access scheme when the number of FDM-ed UEs is 3 (no cyclic shift), in a case that DFT-s-OFDM is used as the access scheme when the number of FDM-ed UEs is 3 (cyclic shift interval 1/4), and in a case that DFT-s-OFDM is used as the access scheme when the number of FDM-ed UEs is 3 (cyclic shift interval 1/2). Also, in FIG. 21, it is assumed that the IFT size (N) is 1024, the FFT size (M) is 340, the total data size is 1020, and the modulation order is QPSK. It is also assumed that the cyclic shift size is (1/4)N and the data allocation offset size is (1/4)M.

Referring to FIG. 21, it can be seen that the PAPR performance is similar when the cyclic shift is applied in the time domain for each UE and when the cyclic shift is applied as a data allocation offset in the input stage.

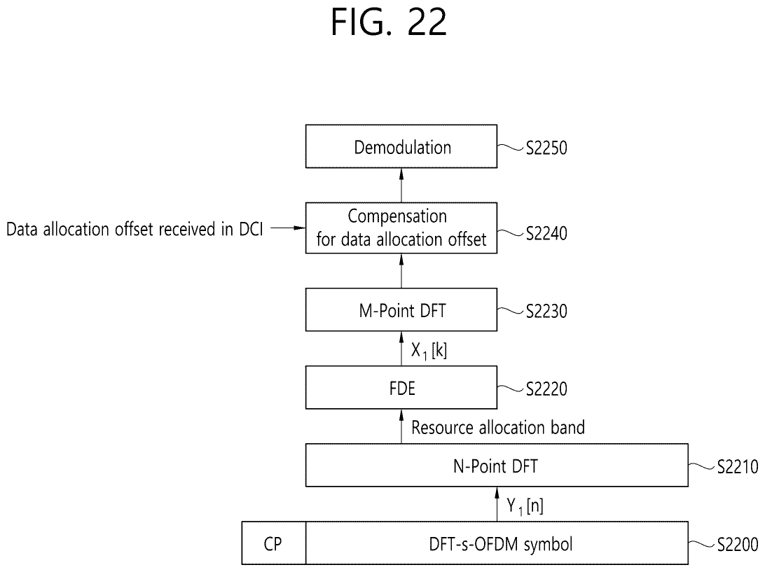

FIG. 22 shows an example of a UE decoding a reception signal by compensating for a data allocation offset to which implementations of the present disclosure are applied.

In step S2200, the UE receives a signal (i.e., a DFT-s-OFDM symbol) over PDSCH. The CP is still attached. It is also assumed that the UE has received the cyclic shift (or cyclic shift index) from the base station in advance.

In step S2210, the UE removes the CP and performs N-point DFT.

In step S2220, the UE performs channel estimation in the frequency domain, i.e., FDE.

In step S2230, the UE performs M-point IDFT.

In step S2240, the UE compensates for the data allocation offset using the data allocation offset received from the base station.

In step S2250, the UE performs demodulation to finally decode the reception signal.

As a result, by applying the cyclic shift for each UE in the time domain as the data [246] allocation offset in the input stage, the complexity increases at the transmitting end, but at the receiving end, the reception signal can be decoded simply by considering the data allocation offset after performing the M-point IDFT.

On the other hand, for PDSCH scheduling of multiple UEs multiplexed by FDMA, dynamic scheduling and Semi-Persistent Scheduling (SPS) may be mixed. In the case of SPS, since it is scheduled by RRC messages and no DCI exists, it is not possible for the base station to deliver the cyclic shift index and/or data allocation offset for every symbol via DCI to the UEs, as in implementations of the present disclosure described above. Therefore, when multiple UEs are multiplexed by FDMA, the base station may indicate via an RRC message that the cyclic shift index and/or data allocation offset according to implementations of the present disclosure is not applied to data destined for such UEs for i) UEs that cannot perform receiving end operations that compensate for the cyclic shift and/or data allocation offset and ii) UEs whose PDSCH is scheduled by the SPS.

The present disclosure can have various advantageous effects.

For example, for DFT-s-OFDM, which is being considered for downlink waveforms in the 5G mmWave band and 6G THz band, when supporting multiple access from multiple UEs via FDMA, the PAPR of the transmitted signal can be reduced by applying a cyclic shift to each UE's time domain signal.

For example, the lower PAPR of the transmitted signal may result in reduced back off power, which in turn may increase the average power of the transmitted signal, resulting in increased power efficiency from the base station perspective.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a base station in a wireless communication system, the method comprising:
performing an initial access with a plurality of User Equipment (UEs);
generating signals for the plurality of UEs;
performing an Inverse Discrete Fourier Transform (IDFT) on each of the signals for the plurality of UEs;
determining a cyclic shift value for each of the plurality of UEs;
applying the cyclic shift value for each of the plurality of UEs to each of the signals for the plurality of UEs on which the IDFT has been performed;
generating a downlink signal by summing each of the signals for the plurality of UEs to which the cyclic shift value has been applied and adding a Cyclic Prefix (CP); and
transmitting the downlink signal.

2. The method of claim 1, wherein the cyclic shift value for each of the plurality of UEs is a cyclic shift value capable of minimizing a Peak-to-Average Power Ratio (PAPR).

3. The method of claim 1, wherein the cyclic shift value for each of the plurality of UEs is a cyclic shift value such that a PAPR is below a threshold value.

4. The method of claim 1, wherein the method further comprises receiving, from each of the plurality of UEs, a UE capability indicative of being able to compensate for the cyclic shift value.

5. The method of claim 1, wherein the method further comprises transmitting the cyclic shift value for each of the plurality of UEs to each of the plurality of UEs via Downlink Control Information (DCI).

6. The method of claim 1, wherein the method further comprises:
generating second signals for each of the plurality of UEs by applying a data allocation offset based on the cyclic shift value for each of the plurality of UEs;
generating a second downlink signal by summing each of the second signals for the plurality of UEs and adding a CP; and
transmitting the second downlink signal.

7. (canceled)

8. A method performed by a User Equipment (UE) in a wireless communication system, the method comprising:
receiving Downlink Control Information (DCI) from a base station over a physical channel;
receiving a reception signal scheduled by the DCI from the base station over a shared channel; and
decoding the reception signal,
wherein decoding of the reception signal comprises:
removing a Cyclic Prefix (CP) from the reception signal;
compensating for a cyclic shift value assigned to the UE; and
decrypting the reception signal.

9. The method of claim 8, wherein the method further comprises reporting, to the base station, a UE capability indicative of being able to compensate for the cyclic shift value for the reception signal.

10. The method of claim 8, wherein the DCI comprises the cyclic shift value.

11. The method of claim 8, wherein the method further comprises, after compensating for the cyclic shift value assigned to the UE, performing an N-point Discrete Fourier Transform (DFT) and an M-point Inverse DFT (IDFT).

12. The method of claim 8, wherein the method further comprises:
performing an N-point DFT before compensating for the cyclic shift value assigned to the UE; and
performing an M-point IDFT after compensating for the cyclic shift value assigned to the UE.

13. The method of claim 8, wherein the method further comprises:
receiving a second reception signal over the shared channel; and
decoding the second reception signal,
wherein decoding of the second reception signal comprises:
removing a CP from the second reception signal;
performing an N-point DFT and an M-point IDFT;
compensating for a data allocation offset based on the cyclic shift value assigned to the UE; and
decrypting the aid second reception signal.

14. The method of claim 13, wherein the DCI comprises the data allocation offset.

15. A User Equipment (UE) operating in a wireless communication system, the UE comprising:
at least one transceiver;
at least one processor; and
at least one memory operably connectable to the at least one processor and storing instructions that, based on being executed by the at least one processor, perform operations comprising:
receiving, using the at least one transceiver, Downlink Control Information (DCI) from a base station over a physical channel;
receiving, using the at least one transceiver, a reception signal scheduled by the DCI from the base station over a shared channel; and
decoding the reception signal,
wherein decoding of the reception signal comprises:
removing a Cyclic Prefix (CP) from the reception signal;
compensating for a cyclic shift value assigned to the UE; and
decrypting the reception signal.

16-17. (canceled)
